(19) United States
(12) Patent Application Publication
(10) Pub. No.: US 2016/0056907 A1
(43) Pub. Date: Feb. 25, 2016

(54) DUAL THRESHOLD BASED CELL CLUSTERING INTERFERENCE MITIGATION FOR eIMTA

(71) Applicants: Chao WEI, (US); Minghai FENG, (US); Neng WANG, (US); Jilei HOU, (US); QUALCOMM INCORPORATED, San Diego, CA (US)

(72) Inventors: Chao Wei, Beijing (CN); Minghai Feng, Beijing (CN); Neng Wang, Beijing (CN); Jilei Hou, Beijing (CN)

(21) Appl. No.: 14/781,157

(22) PCT Filed: May 8, 2014
(86) PCT No.: PCT/CN2014/077023

§ 371 Date: Sep. 29, 2015

(30) Foreign Application Priority Data
May 9, 2013 (CN) PCT/CN2013/075409

(51) Int. Cl. H04J 11/00; H04L 5/14; H04J 3/16

(52) U.S. Cl. CPC H04J 11/005; H04J 3/1694; H04L 5/14

(57) ABSTRACT

Methods, systems, and devices are described for interference mitigation between neighboring cells through the use of cell clusters and virtual logical cell clusters. Cells may be added to a cell cluster with a first cell when a level of interference coupling between the first cell and one or more neighboring cells exceeds a first threshold. One or more other cells may be added to a virtual logical cell cluster with the first cell when the level of interference coupling is between a second threshold and the first threshold, the second threshold being less than the first threshold. Interference mitigation between cells of cell clusters and/or virtual logical cell clusters may be performed. Interference mitigation may be accomplished through, for example, coordination of TDD uplink-downlink (UL-DL) configurations for cell clusters and scheduling-dependent interference management (SDIM) for virtual logical cell clusters.

### CROSS REFERENCES

The present application for patent claims priority to International Patent Application No. PCT/CN2013/075409 to Qualcomm Incorporated et al., entitled “Dual Threshold Based Cell Clustering Interference Mitigation For eIMTA,” filed May 9, 2013, assigned to the assignee hereof, and expressly incorporated by reference herein.

### BACKGROUND

The following relates generally to wireless communication, and more specifically to interference mitigation for neighboring cells in a wireless communications system. Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems. Additionally, some systems may operate using time-division duplex (TDD), in which a single carrier frequency is used for both uplink and downlink communications, and some systems may operate using frequency-division duplex (FDD), in which separate carrier frequencies are used for uplink and downlink communications.

In systems that operate using TDD, different formats may be used in which uplink and downlink communications may be asymmetric. TDD formats include transmission of frames of data, each including a number of different subframes in which different subframes may be uplink or downlink subframes. Reconfiguration of TDD formats may be implemented in some systems based on data traffic patterns of the particular system, in order to provide enhanced uplink or downlink data capacity to users of the system.

### SUMMARY

The described features generally relate to one or more improved methods, systems, and/or apparatuses for wireless communications in which interference between neighboring cells may be mitigated through the use of cell clusters and virtual logical cell clusters. Cells may be added to a cell cluster with a first cell when a level of interference coupling between the first cell and one or more neighboring cells exceeds a first threshold. One or more other cells may be added to a virtual logical cell cluster with the first cell when the level of interference coupling is between a second threshold and the first threshold, the second threshold being less than the first threshold. Interference mitigation between cells of cell clusters and/or virtual logical cell clusters may be performed. Interference mitigation may be accomplished through, for example, coordination of TDD uplink-downlink (UL-DL) configurations for cell clusters and scheduling-dependent interference management (SDIM) for virtual logical cell clusters.

In an aspect of the disclosure, a method for wireless communication by a first cell operating according to time division duplex (TDD) communication is provided. The method generally includes identifying a plurality of neighboring cells of a first cell, determining a level of interference coupling between the first cell and each identified neighboring cell, adding a first neighboring cell to a cell cluster of the first cell when the level of interference coupling of the first neighboring cell exceeds a first threshold, adding a second neighboring cell to a virtual logical cell cluster when the level of interference coupling of the second neighboring cell is between a second threshold and the first threshold, the second threshold being less than the first threshold, and performing interference mitigation between the first cell and one or more cells in the virtual logical cell cluster. In some examples, the method may further include coordinating TDD uplink-downlink (UL-DL) transmissions between the first cell and one or more cells in the cell cluster, such as through coordinating transmit directions of TDD UL-DL subframes of the one or more cells in the cell cluster, for example.

In some examples, performing interference mitigation may include applying one or more scheduling-dependent interference management (SDIM) schemes, such as, for example, one or more of UL and DL power control. In some examples, one or more TDD UL-DL subframes of the first cell and the second neighboring cell have different transmit directions.

In some embodiments, the method may also include changing a TDD UL-DL configuration of the cell cluster, and transmitting an updated TDD UL-DL configuration to each cell in the virtual logical cell cluster. Additionally or alternatively, the method may include receiving an updated TDD UL-DL configuration from a cell in the virtual logical cell cluster, and changing the interference mitigation responsive to the updated TDD UL-DL configuration. In further embodiments, the method may include exchanging TDD UL-DL configuration information between the first cell and each cell of the cell cluster, and exchanging TDD UL-DL configuration information between the first cell and each cell of the virtual logical cell cluster. The TDD UL-DL configuration information may be exchanged, for example, via an X2 interface coupled with the first cell. The TDD UL-DL configuration of cells having interference coupling levels below the second threshold may be modified independently of interference mitigation, according to some embodiments.

In another aspect, the disclosure provides an apparatus for wireless communication in a time division duplex (TDD) wireless communication system. The apparatus generally includes means for identifying a plurality of neighboring cells of a first cell, means for determining a level of interference coupling between the first cell and each identified neighboring cell, means for adding a first neighboring cell to a cell cluster of the first cell when the level of interference coupling of the first neighboring cell exceeds a first threshold, means for adding a second neighboring cell to a virtual logical cell cluster when the level of interference coupling of the second neighboring cell is between a second threshold and the first threshold, the second threshold being less than the first threshold, and means for performing interference mitigation between the first cell and one or more cells in the virtual logical cell cluster.

The apparatus may also include, in some embodiments, means for coordinating TDD uplink-downlink (UL-DL) transmissions between the first cell and one or more cells in the cell cluster. The means for coordinating TDD UL-DL transmissions may include, for example, means for coordinating transmit directions of TDD UL-DL subframes of the one or more cells in the cell cluster.

In some embodiments, the means for performing interference mitigation comprises means for applying one or more scheduling-dependent interference management (SDIM) schemes. The one or more SDIM schemes may include, for example, one or more of UL and DL power control. In some embodiments, the one or more TDD UL-DL subframes of the first cell and the second neighboring cell have different transmit directions.

The apparatus, in some embodiments, may further include means for changing a TDD UL-DL configuration of the cell cluster, and means for transmitting an updated TDD UL-DL configuration to each cell in the virtual logical cell cluster. Additionally or alternatively, the apparatus may include means for receiving an updated TDD UL-DL configuration from a cell in the virtual logical cell cluster, and means for changing the interference mitigation responsive to the updated TDD UL-DL configuration. The apparatus may also include, in some embodiments, means for exchanging TDD UL-DL configuration information between the first cell and each cell of the cell cluster, and means for exchanging TDD UL-DL configuration information between the first cell and each cell of the virtual logical cell cluster. The means for exchanging may be, for example, an X2 interface coupled with the first cell. The TDD UL-DL configuration of cells having interference coupling levels below the second threshold may be modified independently of interference mitigation, according to some embodiments.

In another aspect, the disclosure provides another apparatus for wireless communication in a time division duplex (TDD) wireless communication system. The apparatus generally includes a processor, memory in electronic communication with the processor, and instructions being stored in the memory. The instructions may be executable by the processor to identify a plurality of neighboring cells of a first cell, determine a level of interference coupling between the first cell and each identified neighboring cell, add a first neighboring cell to a cell cluster of the first cell when the level of interference coupling of the first neighboring cell exceeds a first threshold, add a second neighboring cell to a virtual logical cell cluster when the level of interference coupling of the second neighboring cell is between a second threshold and the first threshold, the second threshold being less than the first threshold, and perform interference mitigation between the first cell and one or more cells in the virtual logical cell cluster.

In some embodiments, the instructions may be further executable by the processor to coordinate TDD uplink-downlink (UL-DL) transmissions between the first cell and one or more cells in the cell cluster. The coordination of TDD UL-DL transmissions may include, for example, coordinating transmit directions of TDD UL-DL subframes of the one or more cells in the cell cluster. The interference mitigation may include, in some embodiments, one or more scheduling-dependent interference management (SDIM) schemes, such as one or more of UL and DL power control.

In some embodiments, the instructions may be further executable by the processor to change a TDD UL-DL configuration of the cell cluster, and transmit an updated TDD UL-DL configuration to each cell in the virtual logical cell cluster. Additionally or alternatively, the instructions may be further executable by the processor to receive an updated TDD UL-DL configuration from a cell in the virtual logical cell cluster, and change the interference mitigation responsive to the updated TDD UL-DL configuration. In some embodiments, the instructions may be further executable by the processor to exchange TDD UL-DL configuration information between the first cell and each cell of the cell cluster, and exchange TDD UL-DL configuration information between the first cell and each cell of the virtual logical cell cluster.

In another aspect, the disclosure provides a computer program product for wireless communication in a time division duplex (TDD) wireless communication system. The computer program product generally includes a non-transitory computer-readable medium storing instructions executable by a processor. The instructions may be executable by the processor to identify a plurality of neighboring cells of a first cell, determine a level of interference coupling between the first cell and each identified neighboring cell, add a first neighboring cell to a cell cluster of the first cell when the level of interference coupling of the first neighboring cell exceeds a first threshold, add a second neighboring cell to a virtual logical cell cluster when the level of interference coupling of the second neighboring cell is between a second threshold and the first threshold, the second threshold being less than the first threshold, and perform interference mitigation between the first cell and one or more cells in the virtual logical cell cluster.

In some embodiments, the instructions may be further executable by the processor to coordinate TDD uplink-downlink (UL-DL) transmissions between the first cell and one or more cells in the cell cluster. The coordination of TDD UL-DL transmissions may include, for example, coordinating transmit directions of TDD UL-DL subframes of the one or more cells in the cell cluster. The interference mitigation may include, for example, one or more scheduling-dependent interference management (SDIM) schemes, such as one or more of UL and DL power control.

In some embodiments, the instructions may be further executable by the processor to change a TDD UL-DL configuration of the cell cluster, and transmit an updated TDD UL-DL configuration to each cell in the virtual logical cell cluster. Additionally or alternatively, the instructions may be further executable by the processor to receive an updated TDD UL-DL configuration from a cell in the virtual logical cell cluster, and change the interference mitigation responsive to the updated TDD UL-DL configuration. The instructions, in some embodiments, may be further executable by the processor to exchange TDD UL-DL configuration information between the first cell and each cell of the cell cluster, and exchange TDD UL-DL configuration information between the first cell and each cell of the virtual logical cell cluster.

In another aspect, the disclosure provides another method for wireless communication in a time division duplex (TDD) communication system. The method generally includes identifying a first interference coupling threshold above which a first cell and a neighboring cell are assigned to a same cell cluster, identifying a range of interference coupling levels between a second interference coupling threshold and the first interference coupling threshold for assigning the first cell and the neighboring cell to a virtual logical cell cluster for interference mitigation, and determining whether the first cell and the neighboring cell are to be part of a same cell cluster or a virtual logical cell cluster based on a level of interference coupling between the first cell and the neighboring cell. Cells within a same cell cluster may, for example, coordinate TDD uplink-downlink (UL-DL) transmissions. Interference mitigation for cells in the virtual logical cell cluster may include, for example, applying one or more scheduling-dependent interference management (SDIM) schemes, such as UL and/or DL power control. The TDD UL-DL configuration of cells having interference coupling levels below the second threshold may, in some embodiments, be modified independently of interference mitigation.

In a further aspect, an apparatus for wireless communication in a time division duplex (TDD) communication system is provided. The apparatus generally includes means for identifying a first interference coupling threshold above which a first cell and a neighboring cell are assigned to a same cell cluster, means for identifying a range of interference coupling levels between a second interference coupling threshold and the first interference coupling threshold for assigning the first cell and the neighboring cell to a virtual logical cell cluster for interference mitigation, and means for determining whether the first cell and the neighboring cell are to be part of a same cell cluster or a virtual logical cell cluster based on a level of interference coupling between the first cell and the neighboring cell. Cells within a same cell cluster may, for example, coordinate TDD uplink-downlink (UL-DL) transmissions. The means for performing interference mitigation for cells in the virtual logical cell cluster may include, for example, means for applying one or more scheduling-dependent interference management (SDIM) schemes, such as UL and/or DL power control. The TDD UL-DL configuration of cells having interference coupling levels below the second threshold may, in some embodiments, be modified independently of interference mitigation.

In a further aspect, the disclosure provides an apparatus for wireless communication in a time division duplex (TDD) wireless communication system. The apparatus generally includes a processor, memory in electronic communication with the processor, and instructions being stored in the memory. The instructions may be executable by the processor to identify a first interference coupling threshold above which a first cell and a neighboring cell are assigned to a same cell cluster, identify a range of interference coupling levels between a second interference coupling threshold and the first interference coupling threshold for assigning the first cell and the neighboring cell to a virtual logical cell cluster for interference mitigation, and determine whether the first cell and the neighboring cell are to be part of a same cell cluster or a virtual logical cell cluster based on a level of interference coupling between the first cell and the neighboring cell. Cells within a same cell cluster may, in some examples, coordinate TDD uplink-downlink (UL-DL) transmissions. Interference mitigation for cells in the virtual logical cell cluster may include, for example, one or more scheduling-dependent interference management (SDIM) schemes.

In still a further aspect, the disclosure provides a computer program product for wireless communication in a time division duplex (TDD) wireless communication system. The computer program product includes a non-transitory computer-readable medium storing instructions executable by a processor. The instructions may be executable by the processor to identify a first interference coupling threshold above which a first cell and a neighboring cell are assigned to a same cell cluster, identify a range of interference coupling levels between a second interference coupling threshold and the first interference coupling threshold for assigning the first cell and the neighboring cell to a virtual logical cell cluster for interference mitigation, and determine whether the first cell and the neighboring cell are to be part of a same cell cluster or a virtual logical cell cluster based on a level of interference coupling between the first cell and the neighboring cell. Cells within a same cell cluster may, for example, coordinate TDD uplink-downlink (UL-DL) transmissions. Interference mitigation for cells in the virtual logical cell cluster may include, for example, one or more scheduling-dependent interference management (SDIM) schemes.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a diagram illustrating an example of a wireless communications system in accordance with various embodiments;

FIG. 2 is a table illustrating TDD Uplink-Downlink configurations in a wireless communications system in accordance with various embodiments;

FIG. 3 illustrates a Cell Clustering Interference Mitigation environment with cells grouped according to cell clusters in accordance with various embodiments;

FIG. 4 illustrates cell clusters and virtual logical cell clusters in accordance with various embodiments;

FIG. 5 illustrates different thresholds of interference level coupling levels for a base station;

FIG. 6 shows a block diagram of an example of a base station in accordance with various embodiments;

FIG. 7 shows a block diagram of an example of a user equipment in accordance with various embodiments;

FIG. 8 shows a block diagram of an example of a user equipment and base station in accordance with various embodiments;

FIG. 9 is a flowchart of a method for interference mitigation in accordance with various embodiments;

FIG. 10 is a flowchart of another method for interference mitigation in accordance with various embodiments;

FIG. 11 is a flowchart of yet another method for interference mitigation in accordance with various embodiments; and

FIG. 12 is a flowchart of still another method for interference mitigation in accordance with various embodiments.

### DETAILED DESCRIPTION

Various aspects of the disclosure provide for wireless communications in which interference between neighboring cells may be mitigated through the use of cell clusters and virtual logical cell clusters. Cells may be added to a cell cluster with a first cell when a level of interference coupling between the first cell and one or more neighboring cells exceeds a first threshold. One or more other cells may be added to a virtual logical cell cluster with the first cell when the level of interference coupling is between a second threshold and the first threshold, the second threshold being less than the first threshold. Interference mitigation between cells of cell clusters and/or virtual logical cell clusters may be performed. Interference mitigation may be accomplished through, for example, coordination of TDD uplink-downlink (UL-DL) configurations for cell clusters and scheduling-dependent interference management (SDIM) for virtual logical cell clusters.

Techniques described herein may be used for various wireless communications systems such as cellular wireless systems, Peer-to-Peer wireless communications, wireless local access networks (WLANs), ad hoc networks, satellite communications systems, and other systems. The terms “system” and “network” are often used interchangeably. These wireless communications systems may employ a variety of radio communication technologies such as Code Division Multiple Access (CDMA), Time Division Multiple Access (TDMA), Frequency Division Multiple Access (FDMA), Orthogonal FDMA (OFDMA), Single-Carrier FDMA (SC-FDMA), and/or other radio technologies. Generally, wireless communications are conducted according to a standardized implementation of one or more radio communication technologies called a Radio Access Technology (RAT). A wireless communications system or network that implements a Radio Access Technology may be called a Radio Access Network (RAN).

Examples of Radio Access Technologies employing CDMA techniques include CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. Examples of TDMA systems include various implementations of Global System for Mobile Communications (GSM). Examples of Radio Access Technologies employing OFDM and/or OFDMA include Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

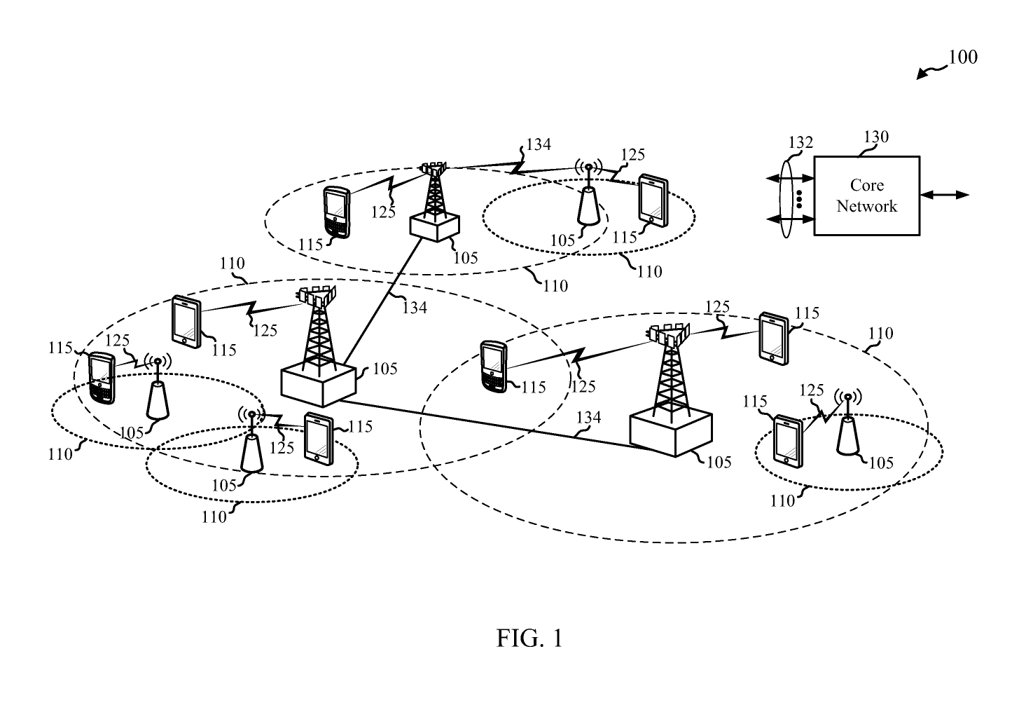

Referring first to FIG. 1, a diagram illustrates an example of a wireless communications system 100. The system 100 includes base stations (or cells) 105, user equipments (UEs) 115, and a core network 130. The base stations 105 may communicate with the UEs 115 under the control of a base station controller (not shown), which may be part of the core network 130 or the base stations 105 in various embodiments. Base stations 105 may communicate control information and/or user data with the core network 130 through backhaul links 132. Backhaul links may be wired backhaul links (e.g., copper, fiber, etc.) and/or wireless backhaul links (e.g., microwave, etc.). In embodiments, the base stations 105 may communicate, either directly or indirectly, with each other over backhaul links 134, which may be wired or wireless communication links. The system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc.

The base stations 105 may wirelessly communicate with the UEs 115 via one or more base station antennas. Each of the base station 105 sites may provide communication coverage for a respective geographic coverage area 110. In some embodiments, base stations 105 may be referred to as a base transceiver station, a radio base station, an access point, a radio transceiver, a basic service set (BSS), an extended service set (ESS), a NodeB, eNodeB (eNB), Home NodeB, a Home eNodeB, or some other suitable terminology. The coverage area 110 for a base station may be divided into sectors making up only a portion of the coverage area (not shown). The system 100 may include base stations 105 of different types (e.g., macro, micro, and/or pico base stations). There may be overlapping coverage areas for different technologies. According to various embodiments, base stations may be assigned to clusters for purposes of interference mitigation. For example, neighboring base stations having relatively high levels of interference coupling may belong to a cell cluster in which communications of the base stations are coordinated (e.g., receive/transmit uplink/downlink communications in a coordinated fashion), and neighboring base stations having moderate levels of interference coupling may employ interference management techniques (e.g., SDIM). Various examples of interference mitigation will be described in further detail below.

The wireless communications system 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. In embodiments, some eNBs 105 may be synchronous while other eNBs may be asynchronous.

The UEs 115 are dispersed throughout the wireless communications system 100, and each device may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a user equipment, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A communication device may be able to communicate with macro base stations, pico base stations, femto base stations, relay base stations, and the like.

The communication links 125 shown in the wireless communications system 100 may include uplink (UL) transmissions from a UE 115 to a base station 105, and/or downlink (DL) transmissions, from a base station 105 to a UE 115. The downlink transmissions may also be called forward link transmissions while the uplink transmissions may also be called reverse link transmissions. In embodiments, the communication links 125 are TDD carriers carrying bidirectional traffic within traffic frames.

In embodiments, the system 100 is an LTE/LTE-A network. In LTE/LTE-A networks, the term evolved Node B (eNB) may be generally used to describe the base stations 105 and UEs 115, respectively. The system 100 may be a Heterogeneous LTE/LTE-A network in which different types of eNBs provide coverage for various geographical regions. For example, each eNB 105 may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. An eNB may support one or multiple (e.g., two, three, four, and the like) cells.

The wireless communications system 100 according to an LTE/LTE-A network architecture may be referred to as an Evolved Packet System (EPS). The EPS may include one or more UEs 115, an Evolved UMTS Terrestrial Radio Access Network (E-UTRAN), an Evolved Packet Core (EPC) (e.g., core network 130), a Home Subscriber Server (HSS), and an Operator's IP Services. The EPS may interconnect with other access networks using other Radio Access Technologies. For example, the EPS may interconnect with a UTRAN-based network and/or a CDMA-based network via one or more Serving GPRS Support Nodes (SGSNs). To support mobility of UEs 115 and/or load balancing, the EPS may support handover of UEs 115 between a source eNB 105 and a target eNB 105. The EPS may support intra-RAT handover between eNBs 105 and/or base stations of the same RAT (e.g., other E-UTRAN networks), and inter-RAT handovers between eNBs and/or base stations of different RATs (e.g., E-UTRAN to CDMA, etc.). The EPS may provide packet-switched services, however, as those skilled in the art will readily appreciate, the various concepts presented throughout this disclosure may be extended to networks providing circuit-switched services.

The E-UTRAN may include the eNBs 105 and may provide user plane and control plane protocol terminations toward the UEs 115. The eNBs 105 may be connected to other eNBs 105 via an X2 interface (e.g., backhaul link 134). The eNBs 105 may provide an access point to the core network (e.g., the EPC) for the UEs 115. The eNBs 105 may be connected by an S1 interface (e.g., backhaul link 132) to the core network 130 (e.g., the EPC). Logical nodes within the core network 130 or EPC may include one or more Mobility Management Entities (MMEs), one or more Serving Gateways, and one or more Packet Data Network (PDN) Gateways (not shown). Generally, the MME may provide bearer and connection management. All user IP packets may be transferred through the Serving Gateway, which itself may be connected to the PDN Gateway. The PDN Gateway may provide UE IP address allocation as well as other functions. The PDN Gateway may be connected to IP networks and/or the operator's IP Services. These logical nodes may be implemented in separate physical nodes or one or more may be combined in a single physical node. The IP Networks/Operator's IP Services may include the Internet, an Intranet, an IP Multimedia Subsystem (IMS), and/or a Packet-Switched (PS) Streaming Service (PSS).

The UEs 115 may be configured to collaboratively communicate with multiple eNBs 105 through, for example, Multiple Input Multiple Output (MIMO), Coordinated Multi-Point (CoMP), or other schemes. MIMO techniques use multiple antennas on the base stations and/or multiple antennas on the UE to take advantage of multipath environments to transmit multiple data streams. CoMP includes techniques for dynamic coordination of transmission and reception by a number of eNBs to improve overall transmission quality for UEs as well as increasing network and spectrum utilization. Generally, CoMP techniques utilize backhaul links 132 and/or 134 for communication between base stations 105 to coordinate control plane and user plane communications for the UEs 115.

The communication networks that may accommodate some of the various disclosed embodiments may be packet-based networks that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARQ) to provide retransmission at the MAC layer to improve link efficiency. In the control plane, the Radio Resource Control (RRC) protocol layer may provide establishment, configuration, and maintenance of an RRC connection between the UE and the network used for the user plane data. At the Physical layer, the transport channels may be mapped to Physical channels.

LTE/LTE-A utilizes orthogonal frequency division multiple-access (OFDMA) on the downlink and single-carrier frequency division multiple-access (SC-FDMA) on the uplink. OFDMA and SC-FDMA partition the system bandwidth into multiple (K) orthogonal subcarriers, which are also commonly referred to as tones, bins, or the like. Each subcarrier may be modulated with data. The spacing between adjacent subcarriers may be fixed, and the total number of subcarriers (K) may be dependent on the system bandwidth. For example, K may be equal to 72, 180, 300, 600, 900, or 1200 with a subcarrier spacing of 15 kilohertz (KHz) for a corresponding system bandwidth (with guardband) of 1.4, 3, 5, 10, 15, or 20 megahertz (MHz), respectively. The system bandwidth may also be partitioned into sub-bands. For example, a sub-band may cover 1.08 MHz, and there may be 1, 2, 4, 8 or 16 sub-bands.

Wireless communications system 100 may support operation on multiple carriers, which may be referred to as carrier aggregation (CA) or multi-carrier operation. A carrier may also be referred to as a component carrier (CC), a channel, etc. The terms “carrier,” “CC,” and “channel” may be used interchangeably herein. A carrier used for the downlink may be referred to as a downlink CC, and a carrier used for the uplink may be referred to as an uplink CC. A UE may be configured with multiple downlink CCs and one or more uplink CCs for carrier aggregation. An eNB may transmit data and control information on one or more downlink CCs to the UE. The UE may transmit data and control information on one or more uplink CCs to the eNB.

The carriers may transmit bidirectional communications FDD (e.g., paired spectrum resources), TDD (e.g., unpaired spectrum resources). Frame structures for FDD (e.g., frame structure type 1) and TDD (e.g., frame structure type 2) may be defined. Each frame structure may have a radio frame length T_{f}=307200·Tₛ=10 ms and may include two half-frames of length 153600·Tₛ=5 ms each. Each half-frame may include five subframes of length 30720·Tₛ=1 ms.

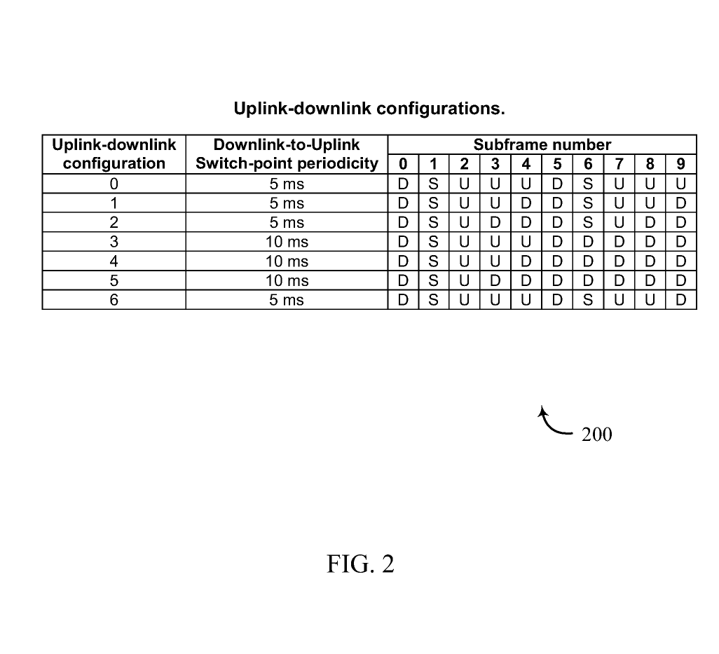

For TDD frame structures, each subframe may carry UL or DL traffic, and special subframes (“S”) may be used to switch between DL to UL transmission. Allocation of UL and DL subframes within radio frames may be symmetric or asymmetric and may be reconfigured semi-statically (e.g., RRC messages via backhaul, etc.). Special subframes may carry some DL and/or UL traffic and may include a Guard Period (GP) between DL and UL traffic. Switching from UL to DL traffic may be achieved by setting timing advance at the UEs without the use of Special subframes or a guard period between UL and DL subframes. UL-DL configurations with switch-point periodicity equal to the frame period (e.g., 10 ms) or half of the frame period (e.g., 5 ms) may be supported. For example, TDD frames may include one or more Special frames, and the period between Special frames may determine the TDD DL-to-UL switch-point periodicity for the frame. For LTE/LTE-A, seven different UL-DL configurations are defined that provide between 40% and 90% DL subframes as illustrated in table FIG. 2 at Table 200. As indicated in table 200, there are two switching periodicities, 5 ms and 10 ms. For configurations with 5 ms switching periodicities, there are two special subframes per frame, and for configurations with 10 ms switching periodicities there is one special subframe per frame. Some of these configurations are symmetric, having the same number of uplink and downlink subframes, while some are asymmetric, having different numbers of uplink and downlink subframes. For example, UL-DL configuration 1 is symmetric, with four uplink and four downlink subframes, UL-DL configuration 5 favors downlink throughput, and UL-DL configuration 0 favors uplink throughput.

The particular TDD UL/DL configuration that is used by a base station may be based on user requirements for the particular coverage area. For example, with reference again to FIG. 1, if a relatively large number of users in a coverage area 110 are receiving more data than they are transmitting, the UL-DL configuration for the associated base station 105 may be selected to favor downlink throughput. Similarly, if a relatively large number of users in a coverage are 110 are transmitting more data than they are receiving, the UL-DL configuration for the associated base station 105 may be selected to favor uplink throughput and the base station 105 may operate using UL-DL configuration 0. In some aspects, a base station 105 may be able to dynamically reconfigure TDD UL-DL configurations on a frame-by-frame basis. For example, in some versions of LTE specifications, it is possible to dynamically adapt TDD DL-UL subframe configurations based on the actual traffic needs, also referred to as evolved Interference Management for Traffic Adaptation (eIMTA). If, during a short duration, a large data burst on downlink is needed, the configuration can be changed from, for example, configuration #1 (6 DL, 4 UL) to configuration #5 (9 DL:1 UL). The adaptation of TDD configuration, in some cases, may be no slower than 640 ms, and in some cases may be as fast as 10 ms. The adaptation, however, may cause significant interference to both downlink and uplink when, for example, two or more neighboring cells have different downlink and uplink subframes. For example, a first cell may be operating in TDD UL-DL configuration #1 (D S U U D D S U U D), and if a neighboring cell were to be operating in TDD UL-DL configuration #3 (D S U U U D D D D D), in the same subframe, an uplink transmission for the first cell may cause interference with a downlink reception for the neighboring cell. According to various embodiments, cells may be assigned to a cell cluster or a virtual logical cell cluster according to a level of interference coupling between base stations, as will be described in more detail below.

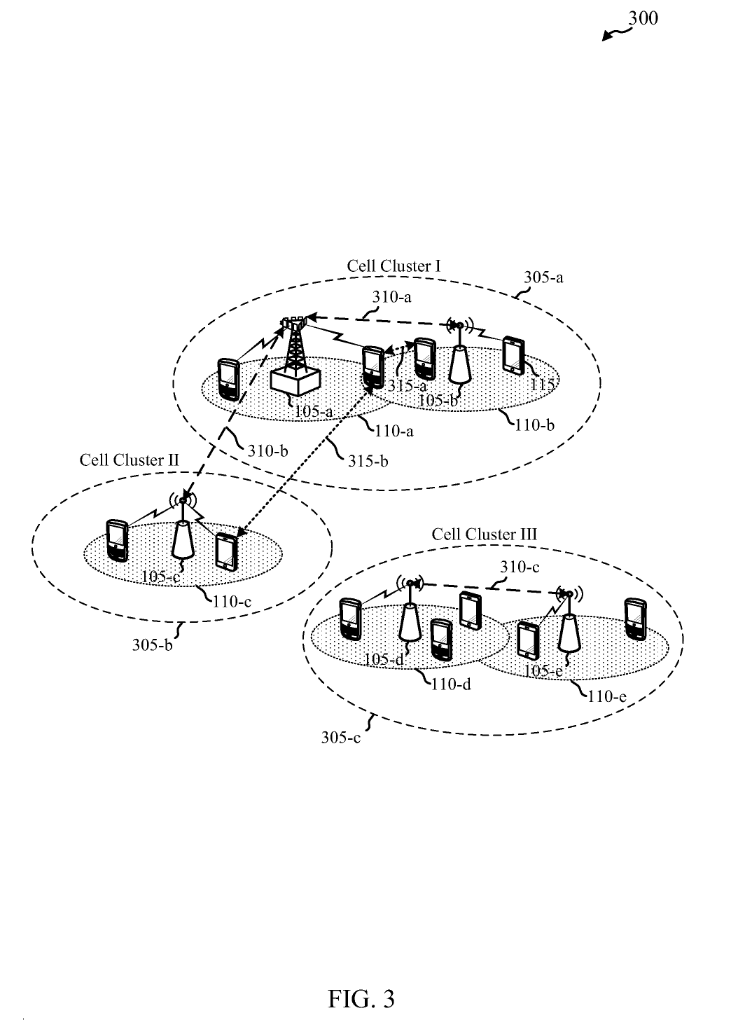

FIG. 3 illustrates a Cell Clustering and Interference Mitigation (CCIM) environment 300 with eNBs grouped according to cell clusters. CCIM environment 300 may illustrate, for example, aspects of wireless communications system 100 illustrated in FIG. 1. Cell clusters can include one or more eNBs and eNBs within a cell cluster may be different types (e.g., macro eNB, pico eNB, femto eNB, and/or the like). As illustrated in the example of FIG. 3, CCIM environment 300 includes cell clusters 305-a, 305-b, and 305-c. Cell cluster 305-a may include eNB 105-a and eNB 105-b, cell cluster 305-b may include eNB 105-c, and cell cluster 305-c may include eNBs 105-d and 105-e. Cell clusters 305 may be statically or semi-statically defined and each eNB 105 in a cell cluster 305 may be aware of the other eNBs 105 of its cluster. Cell clusters 305-a, 305-b, and/or 305-c may deploy TDD carriers and TDD UL-DL configuration within each cell cluster may be synchronized.

Traffic adaptation for synchronized TDD UL-DL configuration within a cell cluster may be performed by coordination of TDD UL-DL reconfiguration between cells of the cluster. Semi-static (e.g., on the order of tens of frames) TDD UL-DL reconfiguration may be performed by exchange of control-plane messaging among eNBs (e.g., via S1 and/or X2 interfaces, etc.). While semi-static TDD UL-DL reconfiguration may provide adequate performance under some conditions, when traffic conditions within the cluster change rapidly, semi-static TDD UL-DL reconfiguration may result in sub-optimal allocation of UL-to-DL subframes for TDD carriers used in the cluster. In some aspects, rapidly changing traffic conditions may be accommodated through allowing the UL-DL configuration for a particular UE 115 may be reconfigured dynamically. Such dynamic reconfiguration may be transmitted to a UE 115 through signaling from the eNB 105, such as through control channel signaling or other techniques, and apply to one or more subsequent TDD frames. Such reconfigurations may be accomplished according to eIMTA, which, as mentioned above, may be implemented in some networks.

As noted above, depending upon the configuration of cells, inter-cell interference may occur. For example, with continued reference to FIG. 3, cell cluster 305-c could, in some scenarios, include eNB 105-d operating according to TDD UL-DL configuration one (having subframe configuration DSUUDDSUUD) and eNB 105-e operating according to TDD UL-DL configuration three (having subframe configuration DSUUUDDDDD). In such a case, uplink transmissions for eNB 105-d in subframes 6, 7 and 8 may interfere with a downlink reception of UEs in communication with eNB 105-e. Thus, according to various embodiments, eNBs 105-d and 105-e may coordinate to reduce the likelihood of such interference. Interference may include, for example, eNB-to-eNB interference, indicated at 310-a, 310-b, and 310-c. Interference may also include, for example, UE-to-UE interference indicated at 315-a and 315-b. According to various embodiments, eNBs 105 may be assigned to a cell cluster 305 and one or more virtual logical cell clusters, as will be described in more detail below, based on an interference level between neighboring cells. When operating according to dynamically reconfigurable TDD UL-DL configurations, according to various embodiments, signaling to indicate the TDD UL-DL configuration of a cell may be provided to other cells in a cluster and one or more virtual logical cell clusters, and eNBs of the cluster and virtual logical cell cluster(s) may perform various interference mitigation techniques responsive to the TDD UL-DL configuration. Methods of signaling TDD configuration may include, for example signaling over the S1 and/or X2 interface link

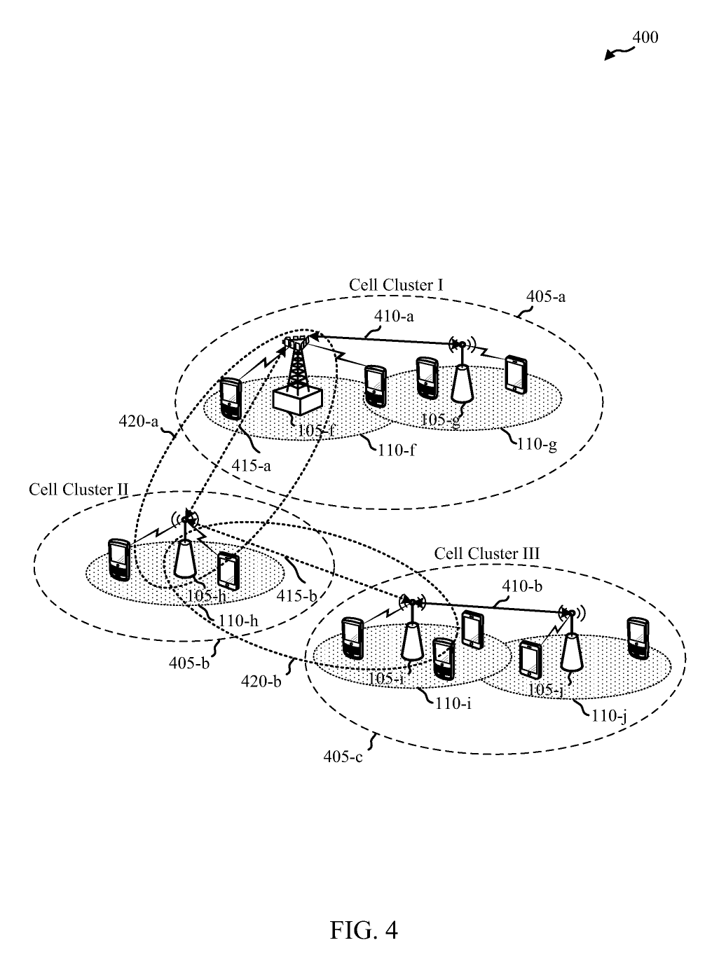

With reference now to FIG. 4, illustrates a Cell Clustering and Interference Mitigation (CCIM) environment 400 with eNBs grouped according to cell clusters and virtual logical cell clusters in accordance with various embodiments. CCIM environment 400 may illustrate, for example, aspects of wireless communications system 100 illustrated in FIG. 1 and/or the CCIM environment 300 illustrated in FIG. 3. Similarly as with FIG. 3, cell clusters can include one or more eNBs and eNBs within a cell cluster may be different types (e.g., macro eNB, pico eNB, femto eNB, and/or the like). As illustrated in the example of FIG. 4, CCIM environment 400 includes cell clusters 405-a, 405-b, and 405-c. Cell cluster 405-a may include eNB 105-f and eNB 105-g, cell cluster 405-b may include eNB 105-h, and cell cluster 405-c may include eNBs 105-i and 105-j. Cell clusters 405 may be statically or semi-statically defined and each eNB 105 in a cell cluster 405 may be aware of the other eNBs 105 of its cluster. Cell clusters 405-a, 405-b, and/or 405-c may deploy TDD carriers and TDD UL-DL configuration within each cell cluster may be synchronized.

As discussed above, TDD reconfiguration, such as may be employed in eIMTA for example, may result in interference between eNBs 105. According to various aspects, the level of interference coupling between eNBs may be determined, and two or more neighboring eNBs may be assigned to a cell cluster 405 if interference coupling is greater than a first threshold. In some examples, a coupling loss may be determined between an eNB 105 and each of a number of neighboring eNBs. The coupling loss, which may be correlated to an interference coupling level between eNBs 105, may be used as an indication of the amount of interference that may be present for transmissions from the eNBs 105. According to some embodiments, eNBs 105 that have coupling loss greater than a threshold are combined into cell clusters 405, and each cluster applies coordinated adaptation of UL-DL configuration taking into account aggregated traffic within the cluster. For example, by setting a coupling threshold (e.g. −90 dB in case of outdoor picocells only) which determines cells in a cluster (and thus coordinated TDD UL-DL configurations), the UL SINR when applying TDD eIMTA may in some cases be improved to a level very close to the case with fixed UL-DL configurations. However, such cell clustering may reduce traffic adaptation flexibility, because all the cells in one cluster are configured with same UL-DL configuration. Thus, if one particular eNB 105 would benefit from a chanced TDD UL-DL configuration, such a change may not in some instances be able to be made. For example, some implementations may employ 4 pico cells per Macro cell, which may result in about 36% of cells belonging to clusters with three or more cells. In deployments using dense pico-cell deployment (e.g. 8 pico cells per Macro cell), only 13% of cells are isolated cells. Thus, cell clustering techniques may limit the flexibility for an eNB 105 to reconfigure its TDD UL-DL configuration.

According to some implementations, a relatively high threshold of coupling loss, such as −70 dB coupling loss instead of −90 dB for example, may be selected to reduce cluster size and increase adaptation flexibility. Such implementations may result in neighboring cells in which interference coupling levels may still be relatively high, and interference mitigation techniques may be implemented for such neighboring cells, such as DL and/or UL power control methods. In some embodiments, two thresholds may be used for cell cluster formation. In such embodiments, cells with a relatively high level of coupling loss, above a first threshold, are added to a same cluster. Such cells may reduce interference through, for example, coordination of TDD UL-DL configurations. In the example of FIG. 4, cell clusters 405-a, 405-b, and 405-c have eNBs 105 that have interference coupling levels above the first threshold. Cells with a moderate level of interference coupling, such as a level of interference coupling above a second threshold but below the first threshold, are added to a virtual logical cell cluster 420-a, 420-b. According to some embodiments, cells in a virtual logical cell cluster may have different transmit directions, and employ one or more interference mitigation techniques. In the example of FIG. 4, eNBs 105-f and 105-h belong to virtual logical cell cluster 420-a, and eNBs 105-h and 105-i belong to virtual logical cell cluster 420-b. Finally, cells with relatively low level of interference coupling, e.g. interference coupling less than the second threshold, may have different TX direction without any interference mitigation applied to the transmissions.

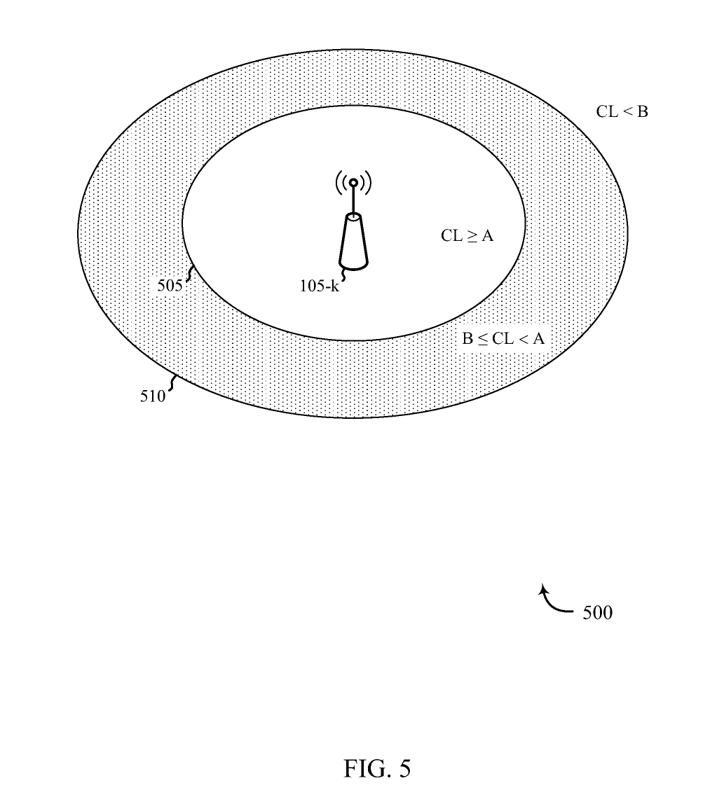

According to some embodiments, cell clusters may be formed or re-formed based on conditions experienced by eNBs 105. An eNB 105 may belong to one physical cell cluster 405 and/or multiple virtual logical cell clusters 420, based on eNB-eNB coupling loss. As noted above, cells in one physical cell cluster 405 may coordinate transmit directions based on aggregated traffic within the cell cluster 405. The eNBs 105 in a same virtual logical cell cluster 420 may have different transmit directions based on traffic needs of the cell, but may apply scheduling-dependent IM schemes (SDIM), such as DL and/or UL power control for example, to mitigate eNB-to-eNB interference. In some embodiments a fixed delta, such as a difference between the first and second thresholds for assigning cells to clusters or virtual logical cell clusters, may be used as a reference for interference mitigation. For example, with reference to virtual logical cell cluster 420-a of FIG. 5, transmit power of eNB 105-h may be reduced by “B-A” dBm to avoid strong interference to eNB 105-i when eNB 105-i is configured for an uplink transmission, so that interference from eNB 105-h to eNB 105-i is compatible to that from eNB 105-g, for example. In some embodiments, TDD UL-DL configurations of neighbor cells in the same cell clusters 405 and virtual logical cell clusters 420, may be exchanged through control-plane messaging among eNBs, such as via the S1 and/or X2 interfaces, for example.

The addition of one or more eNBs 105 to a cell cluster 405 and/or virtual logical cell cluster 420 may be performed in a centralized manner by a network entity (e.g., a master eNB or an entity on the core network), or in a distributed manner by different eNBs 105. For centralized implementations, procedures and X2 signaling may be provided to enable an eNB 105 to request a change of TDD UL-DL configuration due to a change in UL-DL traffic ratio, and to enable the master eNB (or other entity) to instruct other eNBs 105 within the cell cluster 405 which UL-DL configuration to use. The master eNB or other entity may also inform other eNBs 105 in the same virtual logical cell clusters 420 about the selected TDD UL-DL configuration of other cells in the virtual logical cell cluster 420, to enable SDIM for example. In some cases, each eNB 105 may signal to other eNBs 105 in one or more virtual logical cell clusters 420 the current TDD UL-DL configuration. In decentralized implementations, procedures and X2 signaling may be provided to enable an eNB 105 to inform other eNBs within a cell cluster 405 about its traffic pattern and selected UL-DL configuration, and also inform other eNBs 105 in the same virtual logical cell cluster 420 about the selected TDD UL-DL configuration, to enable SDIM, for example. Such implementations may provide for interference control only between edge cells of clusters, rather than between entire clusters, thus providing relatively efficient use of interference mitigation techniques. Furthermore, such implementations may provide efficient exchange of configuration information between cells in same cell clusters and the same virtual logical cell clusters, and may also provide efficient SDIM with fixed delta interference margin.

With reference now to FIG. 5, another example of a dual threshold interference management technique in a CCIM environment 500 is described. In this example, an eNB 105-k has predefined coupling loss thresholds which may be used to assign neighboring cells to the same cell cluster or to a virtual logical cell cluster. In this example, eNB 105-k may implement different interference mitigation schemes for a ring like region defined by coupling levels 505 and 510. The eNB 105-k may compare the coupling loss (or interference coupling level) and corresponding thresholds for each neighboring cell. Different interference mitigation schemes may be identified based on the comparison. For example, if the coupling loss for a neighboring cell is greater than or equal to coupling loss threshold A, identified as the area within the ring defined by coupling level 505 in FIG. 5, the TDD UL-DL configurations of the two cells are coordinated. If the coupling loss for a neighboring cell is less than coupling loss threshold A, but greater than or equal to coupling loss threshold B, identified as the area bounded by coupling levels 505 and 510, the eNB 105-k and neighboring eNB may have different transmit directions and use interference mitigation techniques, such as SDIM schemes, to mitigate interference. If the coupling loss between eNB 105-k and a neighboring eNB is less than threshold B, identified as the area outside the ring defined by coupling level 510, no interference mitigation techniques are required to be implemented. While the example of FIG. 5 is described with reference to coupling loss thresholds, similar techniques may use an interference coupling level between neighboring eNBs that is correlated to coupling loss. For example, eNB 105-k may identify a first interference coupling threshold above which eNB 105-k and a neighboring eNB may be assigned to a same cell cluster.

Similarly, eNB 105-k may identify a range of interference coupling levels between a second interference coupling threshold and the first interference coupling threshold for assigning the eNB 105-k and the neighboring eNB to a virtual logical cell cluster for interference mitigation. Periodically, eNB 105-k may determine whether the neighboring eNB is to be part of a same cell cluster or a virtual logical cell cluster based on a level of interference coupling between eNB 105-k and the neighboring eNB.

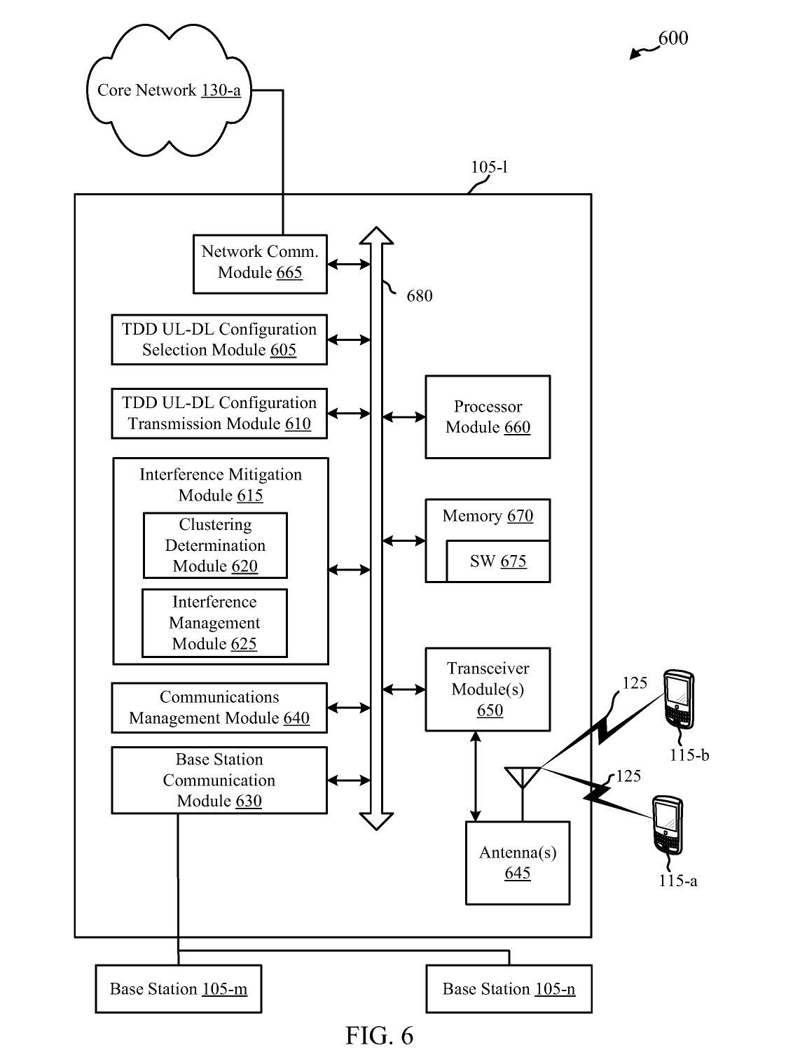

Thus, in order to provide reconfiguration and dynamic resource allocation in eIMTA systems, various aspects of the present disclosure provide for cell clustering based on interference coupling levels. FIG. 6 shows a block diagram of a wireless communications system 600 that may provide for reconfiguration of TDD UL-DL configuration based on cell clustering such as described above. This wireless communications system 600 may be an example of aspects of the system 100 depicted in FIG. 1, CCIM environment 300 of FIG. 3, CCIM environment 400 of FIG. 4, or CCIM environment 500 of FIG. 5. System 600 may include a base station 105-l, which may be an example of a base station of FIG. 1 or 3-5. The base station 105-l may include antenna(s) 645, a transceiver module 650, memory 670, and a processor module 660, which each may be in communication, directly or indirectly, with each other (e.g., over one or more buses 680). The transceiver module 650 may be configured to communicate bi-directionally, via the antenna(s) 645, with UEs 115-a, 115-b. The transceiver module 650 (and/or other components of the base station 105-f) may also be configured to communicate bi-directionally with one or more networks. In some cases, the base station 105-l may communicate with the core network 130-a through network communications module 665. Base station 105-f may be an example of an eNodeB base station, a Home eNodeB base station, a NodeB base station, and/or a Home NodeB base station.

Base station 105-f may also communicate with other base stations 105, such as base station 105-m and base station 105-n. In some cases, base station 105-f may communicate with other base stations such as 105-m and/or 105-n utilizing base station communication module 630. In some embodiments, base station communication module 630 may provide an X2 interface within an LTE wireless communication technology to provide communication between some of the base stations 105. In some embodiments, base station 105-l may communicate with other base stations through core network 130-a.

The memory 670 may include random access memory (RAM) and read-only memory (ROM). The memory 670 may also store computer-readable, computer-executable software code 675 containing instructions that are configured to, when executed, cause the processor module 660 to perform various functions described herein (e.g., TDD UL-DL reconfiguration, cell clustering determination, interference mitigation, etc.). Alternatively, the software code 675 may not be directly executable by the processor module 660 but be configured to cause the processor, e.g., when compiled and executed, to perform functions described herein.

The processor module 660 may include an intelligent hardware device, e.g., a central processing unit (CPU), a microcontroller, an application-specific integrated circuit (ASIC), etc. The transceiver module(s) 650 may include a modem configured to modulate the packets and provide the modulated packets to the antenna(s) 645 for transmission, and to demodulate packets received from the antenna(s) 645. While some examples of the base station 105-l may include a single antenna 645, the base station 105-l may include multiple antennas 645 for multiple links which may support carrier aggregation. For example, one or more links may be used to support macro communications with UEs 115-a, 115-b.

According to the architecture of FIG. 6, the base station 105-l may further include a communications management module 640. The communications management module 640 may manage communications with other base stations 105. By way of example, the communications management module 640 may be a component of the base station 105-l in communication with some or all of the other components of the base station 105-l via a bus 680. Alternatively, functionality of the communications management module 640 may be implemented as a component of the transceiver module 650, as a computer program product, and/or as one or more controller elements of the processor module 660.

In some embodiments, the transceiver module 650 in conjunction with antenna(s) 645, along with other possible components of base station 105-l, may determine TDD UL-DL configurations for various UEs communicating with the base station 105-l. In some embodiments, base station 105-l includes a TDD UL-DL configuration selection module 605 that determines a TDD UL-DL configuration for UEs 115-a, 115-b. At some point, traffic patterns may change such than an initial TDD UL-DL configuration is not optimal for one or more UEs 115-a and 115-b. For example, TDD UL-DL configuration selection module 605 may determine that the UL-DL configuration for UE 115-b is to be reconfigured to a different UL-DL configuration. Reconfiguration information may be provided to UL-DL reconfiguration transmission module 610, which may transmit TDD UL-DL reconfiguration messages, in conjunction with transceiver module(s) 650, to the UE 115-b. Base station 105-l, in the example of FIG. 6, also includes interference mitigation module 615. Interference mitigation module 615 may include clustering determination module 620 and interference management module 625. Clustering determination module 620 may determine cell clusters and/or virtual logical cell clusters to which the base station 105-l, and/or one or more other base stations, are to belong. Clustering determination module 620 may make such determinations using, for example, dual thresholds for interference coupling levels between base station 105-l and neighboring cells, such as described above. Interference management module 625 may provide interference management for base station 105-l, such as through coordination of TDD UL-DL configurations between cells that are in the same cell cluster, and interference mitigation such as SDIM for cells that are in one or more virtual logical cell clusters with base station 105-l, such as described above.

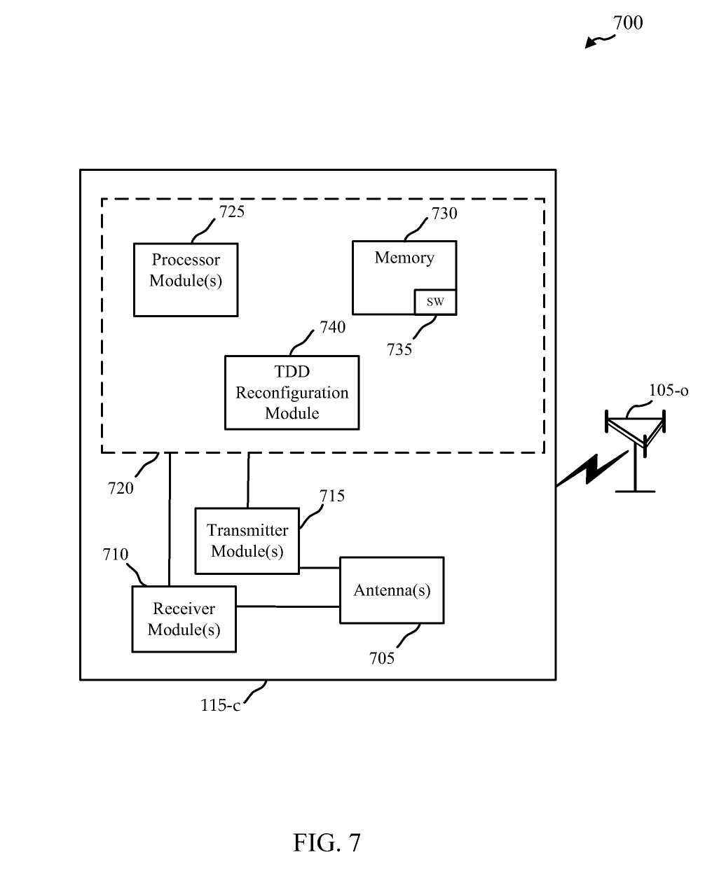

According to some examples, a base station may determine the TDD UL-DL configuration and reconfiguration associated with a UE, and also transmit information related to configuration and reconfiguration to be used for interference management by other base stations. With reference now to FIG. 7, an example wireless communication system 700 that performs TDD UL/DL reconfiguration and related interference management is depicted. System 700 includes a UE 115-c that may communicate with base station 105-o to receive access to one or more wireless networks, and may be an example of aspects of the system 100 of FIG. 1, CCIM environment 300 of FIG. 3, CCIM environment 400 of FIG. 4, CCIM environment 500 of FIG. 5, or system 600 of FIG. 6. UE 115-c may be an example of a user equipment 115 of FIG. 1, 3-4, or 6. UE 115-c, includes one or more antenna(s) 705 communicatively coupled to receiver module(s) 710 and transmitter module(s) 715, which are in turn communicatively coupled to a control module 720. Control module 720 includes one or more processor module(s) 725, a memory 730 that may include computer-executable software code 735, and a TDD reconfiguration module 740. The software code 735 may be for execution by processor module 725 and/or TDD reconfiguration module 740.

The processor module(s) 725 may include an intelligent hardware device, e.g., a central processing unit (CPU), a microcontroller, an application specific integrated circuit (ASIC), etc. The memory 730 may include random access memory (RAM) and read-only memory (ROM). The memory 730 may store computer-readable, computer-executable software code 735 containing instructions that are configured to, when executed (or when compiled and executed), cause the processor module 725 and/or TDD reconfiguration module 740 to perform various functions described herein. The TDD reconfiguration module 740 may be implemented as a part of the processor module(s) 725, or may be implemented using one or more separate CPUs or ASICs, for example. The transmitter module(s) 715 may transmit to base station 105-o (and/or other base stations) to establish communications with one or more wireless communications networks (e.g., E-UTRAN, UTRAN, etc.), as described above. The TDD reconfiguration module 740 may be configured to receive TDD reconfiguration messages from base station 105-o change a TDD UL-DL configuration, and send and receive transmissions according to one or more interference management techniques that may be employed by base station 105-o. The receiver module(s) 710 may receive downlink transmissions from base station 105-g (and/or other base stations), such as described above. Downlink transmissions are received and processed at the user equipment 115-c. The components of UE 115-c may, individually or collectively, be implemented with one or more Application Specific Integrated Circuits (ASICs) adapted to perform some or all of the applicable functions in hardware. Each of the noted modules may be a means for performing one or more functions related to operation of the UE 115-c.

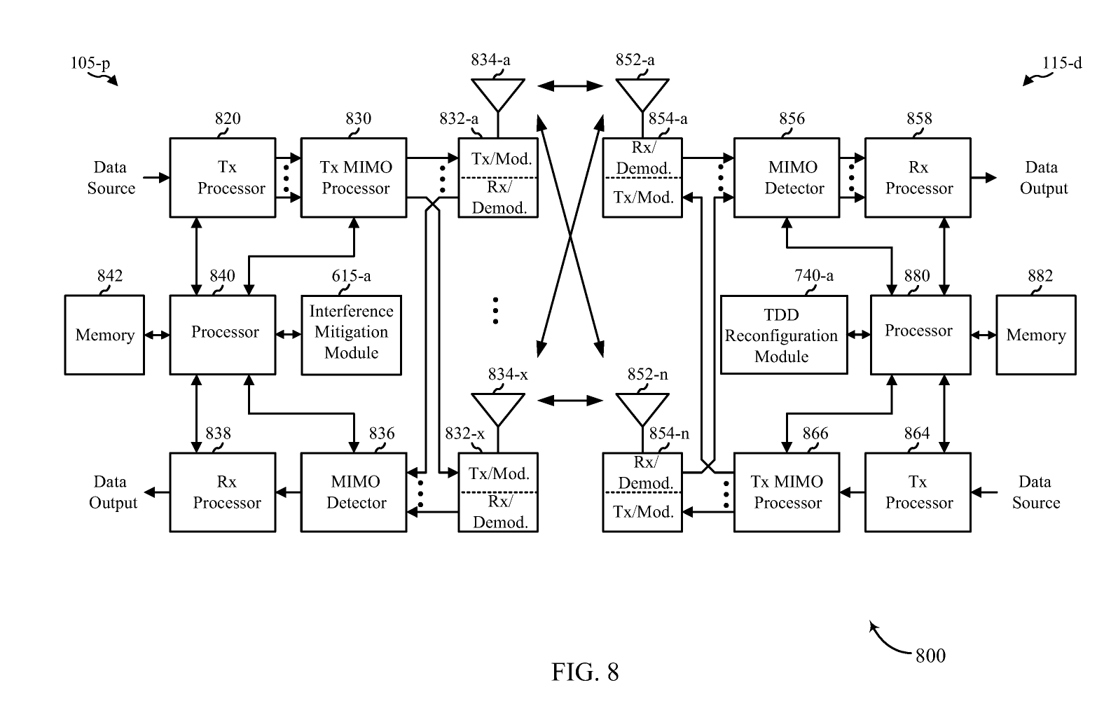

FIG. 8 is a block diagram of a system 800 including a base station 105-p and a UE 115-d. This system 800 may be an example of the system 100 of FIG. 1, CCIM environment 300 of FIG. 3, CCIM environment 400 of FIG. 4, system 600 of FIG. 6, or system 700 of FIG. 7. The base station 105-p may be equipped with antennas 834-a through 834-x, and the UE 115-d may be equipped with antennas 852-a through 852-n. At the base station 105-p, a transmit processor 820 may receive data from a data source.

The transmit processor 820 may process the data. The transmit processor 820 may also generate reference symbols, and a cell-specific reference signal. A transmit (TX) MIMO processor 830 may perform spatial processing (e.g., precoding) on data symbols, control symbols, and/or reference symbols, if applicable, and may provide output symbol streams to the transmit modulators 832-a through 832-x. Each modulator 832 may process a respective output symbol stream (e.g., for OFDM, etc.) to obtain an output sample stream. Each modulator 832 may further process (e.g., convert to analog, amplify, filter, and upconvert) the output sample stream to obtain a downlink (DL) signal. In one example, DL signals from modulators 832-a through 832-x may be transmitted via the antennas 834-a through 834-x, respectively according to a particular TDD Uplink/Downlink configuration.

At the UE 115-d, the UE antennas 852-a through 852-n may receive the DL signals according to the particular TDD Uplink/Downlink configuration from the base station 105-p and may provide the received signals to the demodulators 854-a through 854-n, respectively. Each demodulator 854 may condition (e.g., filter, amplify, downconvert, and digitize) a respective received signal to obtain input samples. Each demodulator 854 may further process the input samples (e.g., for OFDM, etc.) to obtain received symbols. A MIMO detector 856 may obtain received symbols from all the demodulators 854-a through 854-n, perform MIMO detection on the received symbols if applicable, and provide detected symbols. A receive processor 858 may process (e.g., demodulate, deinterleave, and decode) the detected symbols, providing decoded data for the UE 115-d to a data output, and provide decoded control information to a processor 880, or memory 882. The processor 880 may be coupled with a TDD reconfiguration module 740-a that may reconfigure the TDD UL-DL configuration of UE 115-d according to a received reconfiguration message, such as described above. The processor 880 may perform frame formatting according to a current TDD UL/DL configuration, and may thus flexibly configure the TDD UL/DL frame structure based on the current UL/DL configuration of the base station 105-p.

On the uplink (UL), at the UE 115-d, a transmit processor 864 may receive and process data from a data source. The transmit processor 864 may also generate reference symbols for a reference signal. The symbols from the transmit processor 864 may be precoded by a transmit MIMO processor 866 if applicable, further processed by the demodulators 854-a through 854-n (e.g., for SC-FDMA, etc.), and be transmitted to the base station 105-p in accordance with the transmission parameters received from the base station 105-p. At the base station 105-p, the UL signals from the UE 115-d may be received by the antennas 834, processed by the modulators 832, detected by a MIMO detector 836 if applicable, and further processed by a receive processor 838. The receive processor 838 may provide decoded data to a data output and to the processor 840. A memory 842 may be coupled with the processor 840. The processor 840 may perform frame formatting according to a current TDD UL/DL configuration. An interference mitigation module 615-a may, in some embodiments, determine clustering information and related interference mitigation, such as described above. Similarly as discussed above, system 800 may support operation on multiple component carriers, each of which include waveform signals of different frequencies that are transmitted between base station 105-p and UE 115-d. Multiple component carriers may carry uplink and downlink transmissions between UE 115-d and base station 105-p, and base station 105-p may support operation on multiple component carriers that may each have different TDD configurations. The components of the UE 115-d may, individually or collectively, be implemented with one or more Application Specific Integrated Circuits (ASICs) adapted to perform some or all of the applicable functions in hardware. Each of the noted modules may be a means for performing one or more functions related to operation of the system 800. Similarly, the components of the base station 105-p may, individually or collectively, be implemented with one or more Application Specific Integrated Circuits (ASICs) adapted to perform some or all of the applicable functions in hardware. Each of the noted components may be a means for performing one or more functions related to operation of the system 800.

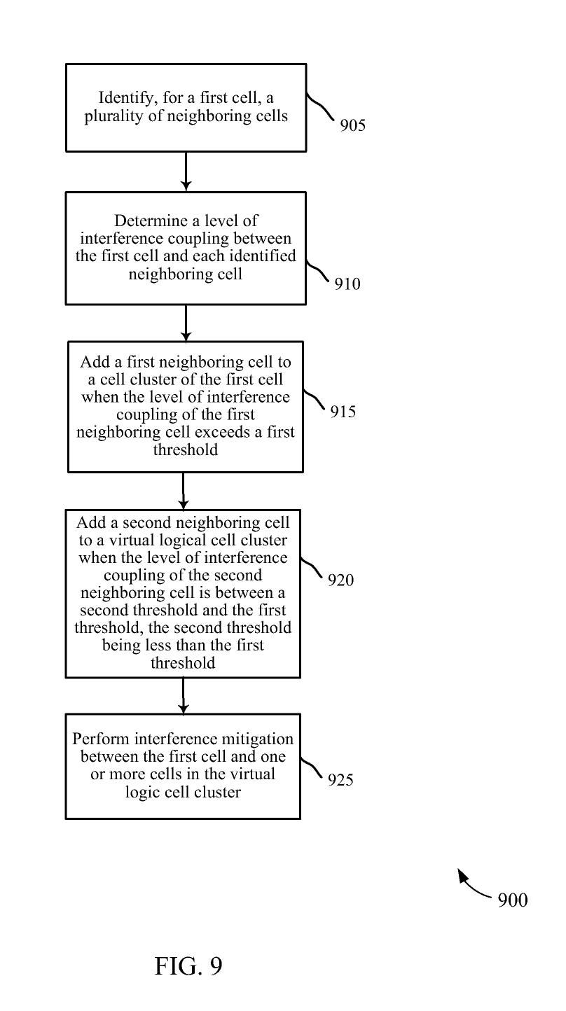

FIG. 9 illustrates a method 900 that may be carried out by one or more components of wireless communications system according to various embodiments. The method 900 may, for example, be performed by an eNB of FIG. 1, or 3-8, an entity located on a core network of FIG. 1 or 6, or using any combination of the devices described for these figures. Initially, at block 905, a plurality of neighboring cells are identified for a first cell. At block 910, a level of interference coupling between the first cell and each identified neighboring cell is determined. A first neighboring cell is added to a cell cluster of the first cell when the level of interference coupling of the first neighboring cell exceeds a first threshold, according to block 915. At block 920, a second neighboring cell is added to a virtual logical cell cluster when the level of interference coupling of the second neighboring cell is between a second threshold and the first threshold, the second threshold being less than the first threshold. Finally, interference mitigation is performed between the first cell and one or more cells in the virtual logical cell cluster, as indicated at block 925. In such a manner, cell clusters and virtual logical cell clusters may be identified to provide enhanced interference mitigation.

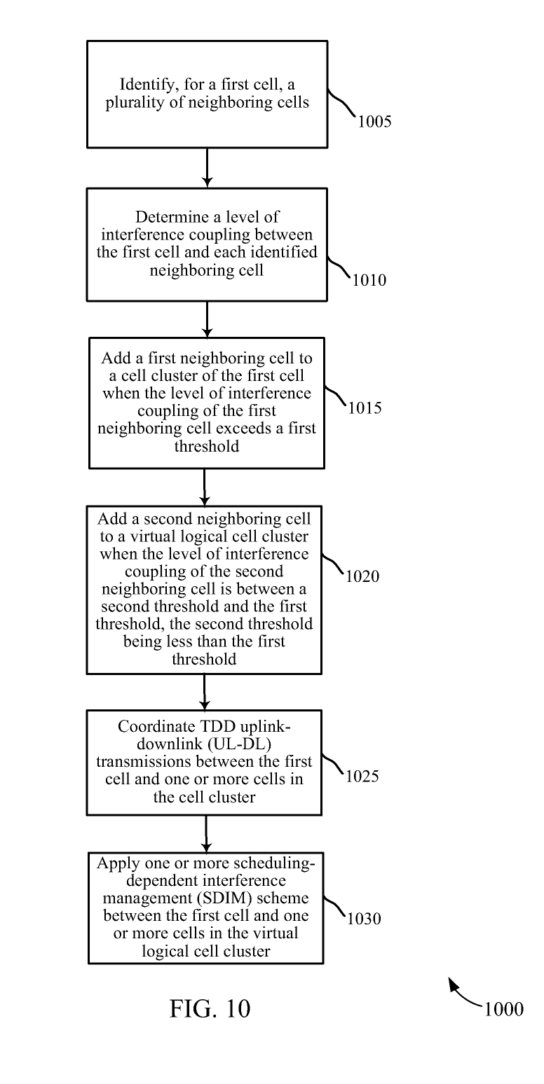

FIG. 10 illustrates another method 1000 that that may be carried out by one or more components of wireless communications system according to various embodiments. The method 1000 may, for example, be performed by an eNB of FIG. 1, or 3-8, an entity located on a core network of FIG. 1 or 6, or using any combination of the devices described for these figures. Initially, at block 1005, a plurality of neighboring cells are identified for a first cell. At block 1010, a level of interference coupling between the first cell and each identified neighboring cell is determined. A first neighboring cell is added to a cell cluster of the first cell when the level of interference coupling of the first neighboring cell exceeds a first threshold, according to block 1015. At block 1020, a second neighboring cell is added to a virtual logical cell cluster when the level of interference coupling of the second neighboring cell is between a second threshold and the first threshold, the second threshold being less than the first threshold. At block 1025, TDD uplink-downlink (UL-DL) transmissions are coordinated between the first cell and one or more cells in the cell cluster, thereby providing interference mitigation for cells of the cell cluster. At block 1030, one or more SDIM schemes are applied between the first cell and one or more cells in the virtual logical cell cluster.

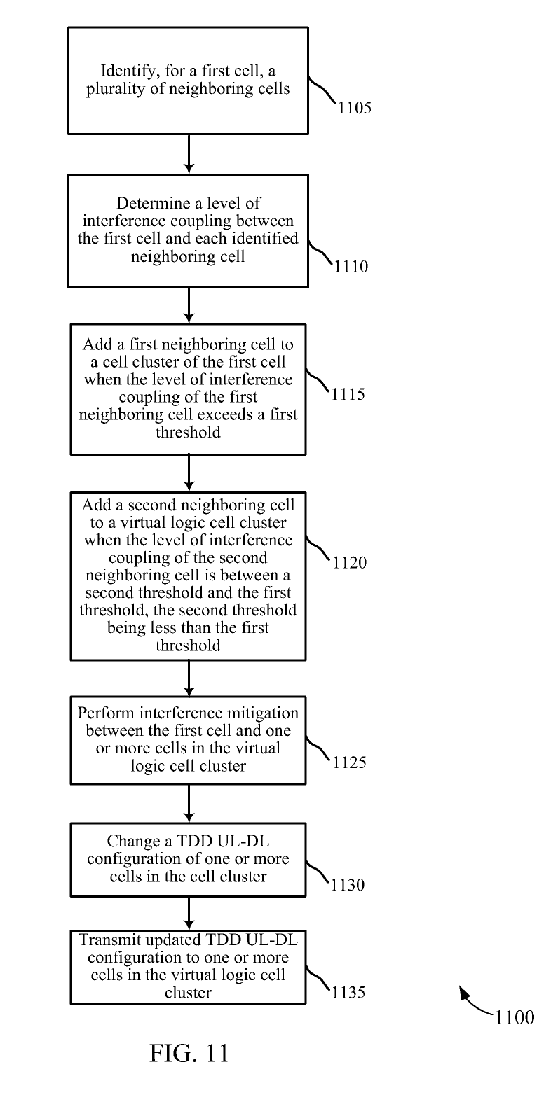

FIG. 11 illustrates a method 1100 that that may be carried out by one or more components of wireless communications system according to various embodiments. The method 1100 may, for example, be performed by an eNB of FIG. 1, or 3-8, an entity located on a core network of FIG. 1 or 6, or using any combination of the devices described for these figures. Initially, at block 1105, a plurality of neighboring cells are identified for a first cell. At block 1110, a level of interference coupling between the first cell and each identified neighboring cell is determined. A first neighboring cell is added to a cell cluster of the first cell when the level of interference coupling of the first neighboring cell exceeds a first threshold, according to block 1115. At block 1120, a second neighboring cell is added to a virtual logical cell cluster when the level of interference coupling of the second neighboring cell is between a second threshold and the first threshold, the second threshold being less than the first threshold. At block 1125, interference mitigation is performed between the cell and one or more cells in the virtual logic cell cluster. At block 1130, a TDD UL-DL configuration of one or more cells in the cell cluster is changed. Such a change may result, for example, from a reconfiguration of the TDD UL-DL configuration for one or more of the cells in the cell cluster. Finally, at block 1135, an updated TDD UL-DL configuration is transmitted to one or more cells in the virtual logic cell cluster. Such transmission may be transmitted via the X1 interface, for example.

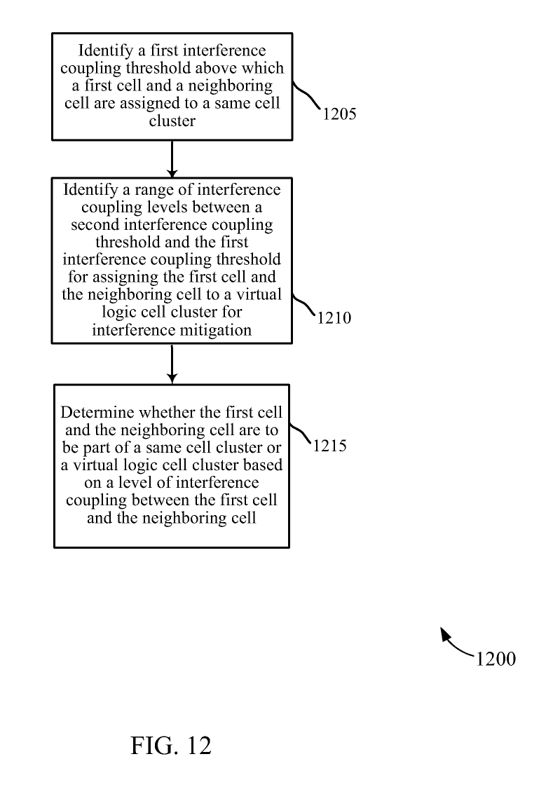

FIG. 12 illustrates another method 1200 that that may be carried out by one or more components of wireless communications system according to various embodiments. The method 1200 may, for example, be performed by an eNB of FIG. 1, or 3-8, an entity located on a core network of FIG. 1 or 6, or using any combination of the devices described for these figures. Initially, at block 1205, a first interference coupling threshold is identified, above which a first cell and a neighboring cell are assigned to a same cell cluster. At block 1210, a range of interference coupling levels is identified between a second interference coupling threshold and the first interference coupling threshold for assigning the first cell and the neighboring cell to a virtual logical cell cluster for interference mitigation. Finally, at block 1215, it is determined whether the first cell and the neighboring cell are to be part of a same cell cluster or a virtual logical cell cluster based on a level of interference coupling between the first cell and the neighboring cell. Cells within a same cell cluster may coordinate TDD UL-DL transmissions, for example, while interference mitigation for cells in the virtual logical cell cluster may include applying one or more scheduling-dependent interference management (SDIM) schemes.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for wireless communication in a time division duplex (TDD) communication system, comprising:
identifying a plurality of neighboring cells of a first cell;
determining a level of interference coupling between the first cell and each identified neighboring cell;
adding a first neighboring cell to a cell cluster of the first cell when the level of interference coupling of the first neighboring cell exceeds a first threshold;
adding a second neighboring cell to a virtual logical cell cluster when the level of interference coupling of the second neighboring cell is between a second threshold and the first threshold, the second threshold being less than the first threshold; and
performing interference mitigation between the first cell and one or more cells in the virtual logical cell cluster.

2. The method of claim 1, further comprising
coordinating TDD uplink-downlink (UL-DL) transmissions between the first cell and one or more cells in the cell cluster.

3. The method of claim 2, wherein coordinating TDD UL-DL transmissions comprises coordinating transmit directions of TDD UL-DL subframes of the one or more cells in the cell cluster.

4. The method of claim 1, wherein performing interference mitigation comprises applying one or more scheduling-dependent interference management (SDIM) schemes.

5. The method of claim 4, wherein the one or more SDIM schemes comprise one or more of uplink (UL) and downlink (DL) power control.

6. The method of claim 2, wherein one or more TDD uplink-downlink (UL-DL) subframes of the first cell and the second neighboring cell have different transmit directions.

7. The method of claim 1, further comprising:
changing a TDD uplink-downlink (UL-DL) configuration of the cell cluster; and
transmitting an updated TDD UL-DL configuration to each cell in the virtual logical cell cluster.

8. The method of claim 1, further comprising:
receiving an updated TDD uplink-downlink (UL-DL) configuration from a cell in the virtual logical cell cluster; and
changing the interference mitigation responsive to the updated TDD UL-DL configuration.

9. The method of claim 1, further comprising:
exchanging TDD uplink-downlink (UL-DL) configuration information between the first cell and each cell of the cell cluster; and
exchanging TDD UL-DL configuration information between the first cell and each cell of the virtual logical cell cluster.

10. The method of claim 9, wherein the TDD UL-DL configuration information is exchanged via an X2 interface coupled with the first cell.

11. The method of claim 1, wherein a TDD uplink-downlink (UL-DL) configuration of cells having interference coupling levels below the second threshold may be modified independently of the interference mitigation.

12. An apparatus for wireless communication in a time division duplex (TDD) wireless communication system, comprising:
means for identifying a plurality of neighboring cells of a first cell;
means for determining a level of interference coupling between the first cell and each identified neighboring cell;
means for adding a first neighboring cell to a cell cluster of the first cell when the level of interference coupling of the first neighboring cell exceeds a first threshold;
means for adding a second neighboring cell to a virtual logical cell cluster when the level of interference coupling of the second neighboring cell is between a second threshold and the first threshold, the second threshold being less than the first threshold; and
means for performing interference mitigation between the first cell and one or more cells in the virtual logical cell cluster.

13. The apparatus of claim 12, further comprising
means for coordinating TDD uplink-downlink (UL-DL) transmissions between the first cell and one or more cells in the cell cluster.

14. The apparatus of claim 13, wherein the means for coordinating TDD UL-DL transmissions comprises means for coordinating transmit directions of TDD UL-DL subframes of the one or more cells in the cell cluster.

15. The apparatus of claim 12, wherein the means for performing interference mitigation comprises means for applying one or more scheduling-dependent interference management (SDIM) schemes.

16. The apparatus of claim 15, wherein the one or more SDIM schemes comprise one or more of uplink (UL) and downlink (DL) power control.

17. The apparatus of claim 13, wherein one or more TDD uplink-downlink (UL-DL) subframes of the first cell and the second neighboring cell have different transmit directions.

18. The apparatus of claim 12, further comprising:
means for changing a TDD uplink-downlink (UL-DL) configuration of the cell cluster; and
means for transmitting an updated TDD UL-DL configuration to each cell in the virtual logical cell cluster.

19. The apparatus of claim 12, further comprising:
means for receiving an updated TDD uplink-downlink (UL-DL) configuration from a cell in the virtual logical cell cluster; and
means for changing the interference mitigation responsive to the updated TDD UL-DL configuration.

20. The apparatus of claim 12, further comprising:
means for exchanging TDD uplink-downlink (UL-DL) configuration information between the first cell and each cell of the cell cluster; and
means for exchanging TDD UL-DL configuration information between the first cell and each cell of the virtual logical cell cluster.

21. The apparatus of claim 20, wherein the TDD UL-DL configuration information is exchanged via an X2 interface coupled with the first cell.

22. The apparatus of claim 12, wherein a TDD uplink-downlink (UL-DL) configuration of cells having interference coupling levels below the second threshold may be modified independently of the interference mitigation.

23. An apparatus for wireless communication in a time division duplex (TDD) wireless communication system, comprising:
a processor;
memory in electronic communication with the processor; and
instructions being stored in the memory, the instructions being executable by the processor to:
identify a plurality of neighboring cells of a first cell;
determine a level of interference coupling between the first cell and each identified neighboring cell;
add a first neighboring cell to a cell cluster of the first cell when the level of interference coupling of the first neighboring cell exceeds a first threshold;
add a second neighboring cell to a virtual logical cell cluster when the level of interference coupling of the second neighboring cell is between a second threshold and the first threshold, the second threshold being less than the first threshold; and
perform interference mitigation between the first cell and one or more cells in the virtual logical cell cluster.

24. The apparatus of claim 23, wherein the instructions are further executable by the processor to:
coordinate TDD uplink-downlink (UL-DL) transmissions between the first cell and one or more cells in the cell cluster.

25. The apparatus of claim 23, wherein the interference mitigation comprises one or more scheduling-dependent interference management (SDIM) schemes.

26. The apparatus of claim 25, wherein the one or more SDIM schemes comprise one or more of uplink (UL) and downlink (DL) power control.

27. The apparatus of claim 24, wherein one or more TDD uplink-downlink (UL-DL) subframes of the first cell and the second neighboring cell have different transmit directions.

28. The apparatus of claim 23, wherein the instructions are further executable by the processor to:
change a TDD uplink-downlink (UL-DL) configuration of the cell cluster; and
transmit an updated TDD UL-DL configuration to each cell in the virtual logical cell cluster.

29. The apparatus of claim 23, wherein the instructions are further executable by the processor to:
receive an updated TDD uplink-downlink (UL-DL) configuration from a cell in the virtual logical cell cluster; and
change the interference mitigation responsive to the updated TDD UL-DL configuration.

30. A computer program product for wireless communication in a time division duplex (TDD) wireless communication system, the computer program product comprising a non-transitory computer-readable medium storing instructions executable by a processor to:
identify a plurality of neighboring cells of a first cell;
determine a level of interference coupling between the first cell and each identified neighboring cell;
add a first neighboring cell to a cell cluster of the first cell when the level of interference coupling of the first neighboring cell exceeds a first threshold;
add a second neighboring cell to a virtual logical cell cluster when the level of interference coupling of the second neighboring cell is between a second threshold and the first threshold, the second threshold being less than the first threshold; and
perform interference mitigation between the first cell and one or more cells in the virtual logical cell cluster.
